(19) United States
(12) Patent Application Publication
(10) Pub. No.: US 2019/0285758 A1
(43) Pub. Date: Sep. 19, 2019

(54) Integrated Multi Slice X-ray Detector for In-Line Computed Tomography

(71) Applicant: Linbo Yang, Pleasanton, CA (US)

(72) Inventor: Linbo Yang, Pleasanton, CA (US)

(21) Appl. No.: 16/199,154

(22) Filed: Nov. 24, 2018

Related U.S. Application Data
(60) Provisional application No. 62/596,788, filed on Dec. 9, 2017.

(51) Int. Cl. G01T 1/20; G01T 1/164; G01T 1/24

(52) U.S. Cl. CPC G01T 1/2018; G01T 1/244; G01T 1/241; G01T 1/1644

(57) ABSTRACT

In accordance with some embodiments of the invention, an x-ray image detector for generating signals in response to an x-ray beam is presented. The x-ray image detector comprises two-dimensional (2D) pixel arrays in a single substrate so that signal from every pixel can be simultaneously collected. A layer of x-ray scintillating material is applied in front of the 2D array. A plurality of detector can be arranged as tiled detector arrays using chip on-board technology. When multiple on-board detectors are arranged and mounted on a curve gantry along with X-ray source on the opposite side, the X-ray detector system is therefore can be used for compact, low cost multi slice in-line CT application. Peripheral circuits can be located in the same substrate or in a different substrate to ensure individual detector signal can be read out parallel.

### FIELD OF THE INVENTION

The present invention pertains generally to the field of solid-state image sensor for use of X-ray multi slice computed tomography (CT).

### BACKGROUND OF THE INVENTION

This application relates generally to X-ray detectors for CT systems.

In modern high volume industrial environment, regular 2D X-ray radiography is a common practice for inspection of parts at production line.

However, existing 2D X-ray in-line radiography inspection systems usually can only detect X and Y location of a defect but not depth of defects at Z direction. As a result, some expensive parts have to be discarded to avoid risk whenever a defect is found at X and Y because of no knowledge of Z location. The fact is that various defects can be classified as a critical defect or a non-critical defect depending on the depth under a surface. If somehow user can have defect info at Z location then only parts with a critical defect will be discarded and parts with non-critical defect will be saved. This will save manufacturer a lot of resources.

Computed tomography is a 3D imaging technique that has been widely used in medical, security and industrial field. By analyzing the accumulated 3D data from reconstruction of a matrix, which constitutes a depiction of a density function of the object section being examined, internal defects of an object can be located precisely in 3D location.

Currently a multi slice CT or multi row apparatus makes it possible to measure a plural number of projection data simultaneously by dividing detectors into a plural number of rows to obtain a high quality slice images.

In this CT system, its components include X-ray source, fan beam, imaging detector, readout electronics, data acquisition, image reconstruction and visualization software etc. X-ray source, fan beam, imaging detector, readout electronics, data acquisition are all in a rotational gantry. And imaging detector mounting usually has a curved geometry.

An x-ray source and a detector apparatus are positioned on opposite sides of a portion of an inspection object. The X-ray source generates and directs an x-ray beam towards the object, while the detector apparatus measures the x-ray absorption at a plurality of transmission paths defined by the x-ray beam during the inspection process.

As the x-ray passes through an object near center, the X-ray beam is attenuated. During a scan to acquire x-ray projection data, gantry and whole electrical components mounted inside rotate around a center of rotation axis.

Rotation of gantry and operation of X-ray source is controlled by CT main control system. Gantry motor controller controls the rotation speed and position of gantry.

Read-out electronics and DAQ system provide digitized data from X-ray detector and send data to a computer. An image reconstructor at computer receives digitized X-ray data and performs high speed image reconstruction. Reconstructed image is then displayed and analyzed to determine object defect status immediately.

One goal of the present invention is to provide a multi slice CT apparatus with which it is possible to obtain high quality in-line CT image at an industrial high volume production environment with much lower cost.

Therefore, this kind of CT apparatus can be used to inspect large volume objects at an industrial production line because parts are transported at a constant speed through the gantry during CT scan.

By taking thousands of readings from multiple angles around the object, relatively massive amounts of data are thus accumulated. Multi slice detector arrays can increase the data rate by scanning a given volume with multiple parallel image slices at the same time.

In order to create better resolution between slices, CT scanners have been developed so that an increased numbers of detectors in the rotational axis direction are applied.

In theory, more scan slice would result in more parallel images that can be taken and processed and even faster speed. However, there is a trade-off between number of multiple image slices and quality of each image slice.

When numbers of multi slices increased, detectors behave more like a larger 2D imager, the X-ray scatter from object become increasingly significant, it is especially true when X-ray kV goes beyond 160 kV in an industrial environment.

A helical scan is a very important in-line non-stop inspection feature in a production line where X-ray inspection data can be taken while object is having a non-stop translational motion and gantry is rotating continuously.

There are a number of different kinds of detectors associated with a multi slice CT. One of most popular approaches is to use 2D photodiode arrays.

One disadvantage of 2D photodiode detector arrays is usually not integrated and need bulky peripheral electronics. Their cost is relatively high.

In this invention, we propose a low cost integrated semiconductor detector for in-line multi slice CT application.

In a current typical industrial X-ray inspection like that in food inspection, use of integrated Linear Diode Array (LDA) detector is very popular. Longer length LDA is composed of multiple group of shorter length LDA where readout clock is from a single global source so that for given exposure time period data on every single line in LDA can be readout simultaneously. The integrated semiconductor CT detector can use similar readout strategy or structure as that in an integrated LDA semiconductor detector in order to be cost effective. By re-arranging LDA pixels into a 2D array pixel configuration, also providing a readout clock from a single source, it will guarantee that all the data at different slice location can be collected simultaneously.

To increase CT data rate, readout electronics architecture has to be in such a way so that its readout is as parallel as possible. It would be the best that there is an analog-to-digital-converter (ADC) readout channel for very single integrated array chip in order to achieve the highest possible readout speed.

In this invention, electrically connecting a multi slice computed tomography (CT) detector module to a CT system becomes even simpler in order to avoid bulky electronics structure at the gantry because it is just like standard industrial LDA type electronics.

An industrial CT (iCT) system cost would be much lower if this kind of integrated detector is arranged. A radiation damage resistant X-ray detector array system based on a unique buttable image sensor design and precision chip-on-board assembly technology includes at least one of the detector chips. Multiple chips of the image sensor may be butted end-to-end on a common printed circuit board to accommodate larger detection systems. A layer of low cost scintillating material, such as GdOS:Tb (GOS) is placed on the image sensor to convert the impinging X-ray energies into visible light which can be detected efficiently by the image sensor array. A protective metal shield is fastened to the substrate to protect the sensitive circuits of the image sensor from X-ray radiation damage. A proper separation of sensitive circuits from the photodiode array on the sensor chip, coupled with precision registration of the sensor chips on the substrate, allows easy installation of a curved geometry on a gantry.

### SUMMARY OF THE INVENTION

The present invention is directed to a system for providing cost-effective detector with easier assembly in X-ray in-line multi slice computed tomography (CT).

An x-ray image detector comprises two-dimensional (2D) pixel arrays in a single substrate so that signal from every pixel can be simultaneously collected. A layer of x-ray scintillating material is applied in front of the 2D array.

The detector has a cascade of imager that includes a conversion layer configured to generate light photons in response to a radiation, a photo detector array aligned with the PCB, each photo detector array have plurality of lines of detector elements and application specific integrated circuit (ASIC) can collect signals from detector elements simultaneously.

A plurality of detector can be arranged as tiled detector arrays using chip on-board technology. When multiple on-board detectors are arranged and mounted on a curve gantry along with X-ray source on opposite side, the X-ray detector system is therefore can be used for compact, low cost multi slice in-line CT application.

X-ray flux is generated by an X-ray source at one side of rotating gantry, transmits through the object and then detected by detectors at other side of rotating gantry while the object is moving so that and a plural number of spiral projection data is acquired from detector.

Peripheral circuits can be located in the same substrate or in a different substrate to ensure individual detector signal can be collected parallel. The peripheral circuits are also compatible with electronics at standard integrated LDA detector.

Various other features and advantages of the present invention will be made apparent from the following detailed description and the drawings.

### BRIEF DESCRIPTION OF THE DRAWINGS

FIG. 1 shows a typical application of X-ray in-line industrial CT using integrated multi-slice detector.

FIG. 2 shows a multi slice pixel array and their processing circuit in a single substrate.

FIG. 3 shows a pair of single substrate multi slice pixel arrays is head-to-head assembled.

FIG. 4 shows a multi slice pixel array and their processing circuit in separate substrates.

FIG. 5 shows a pair of two-substrate multi slice pixel arrays is head-to-head assembled.

FIG. 6 shows a basic single substrate multi slice X-ray detector.

FIG. 7 shows a pair of single substrate multi slice X-ray detector.

FIG. 8 shows a curved assembly of integrated multi slice X-ray detector.

### DETAILED DESCRIPTION OF THE INVENTION

The present invention is a multi line X-ray detector for industrial CT (iCT).

Multi line structure or multi slice structure is arranged in a substrate as multi slice pixel array 10. Processing circuit 6 can be in the same substrate of integrated sensor array 5 or in a different substrate as processing circuit substrate 9. Total numbers of slices are usually 8, 16, 32 and 64 etc.

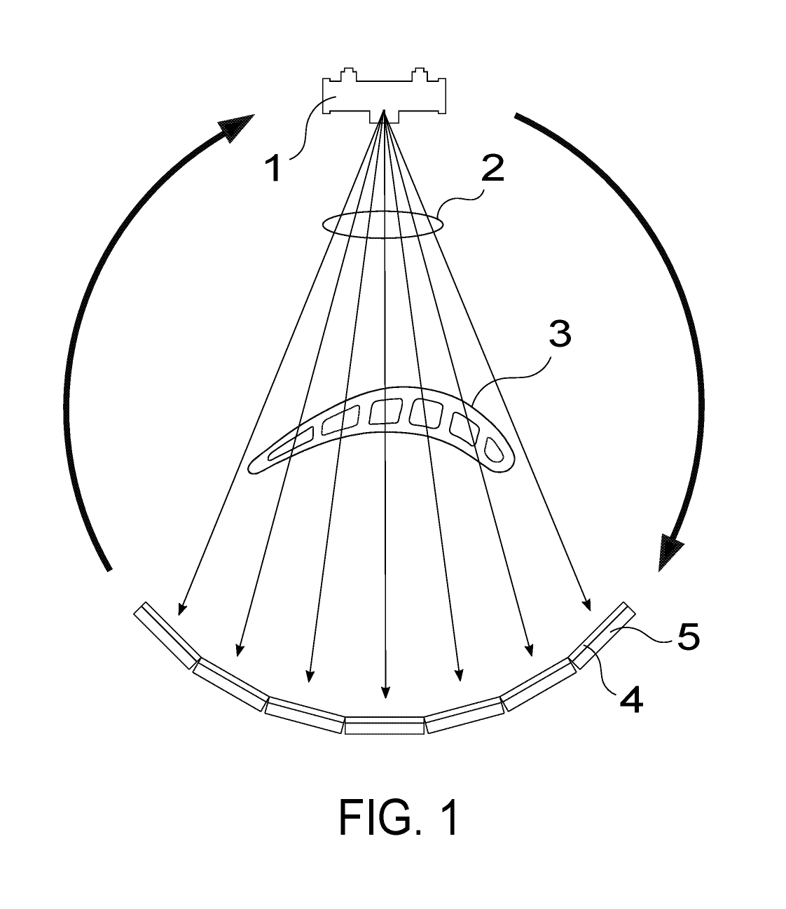

Referring to FIG. 1, a typical implementation of industrial CT using a multi slice X-ray detector is shown. A multi slice X-ray detector comprises scintillating material 4, integrated sensor array 5 and processing circuit 6. X-ray source 1 generates X-ray beam 2. When scan objects 3 pass through X-ray beam 2, the image signal will be registered in the integrated sensor array 4. X-ray source 1 and multi line X-ray detector are in a rotational gantry.

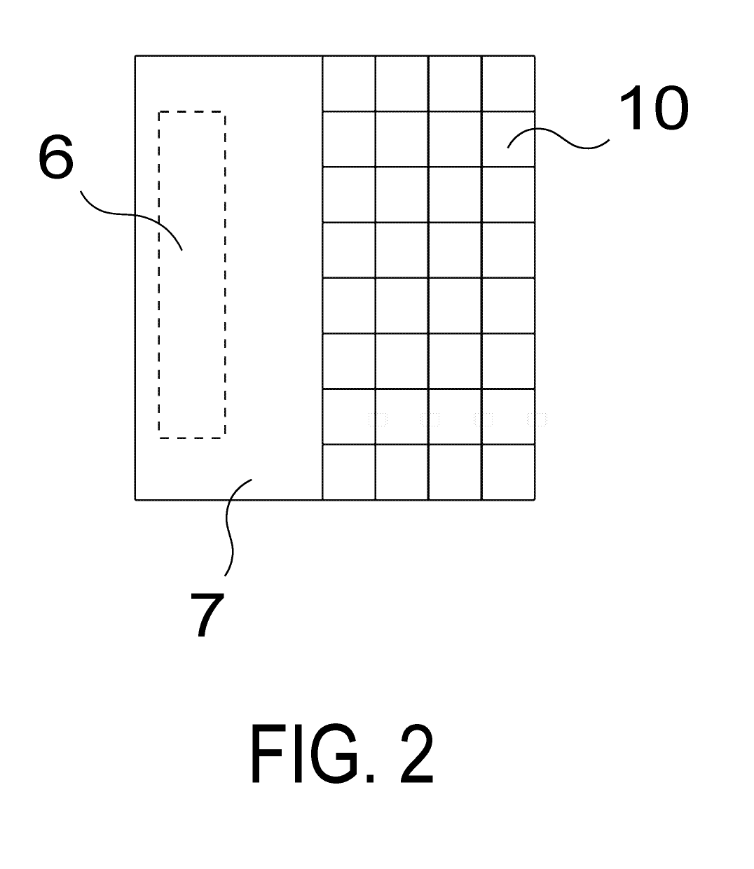

FIG. 2 shows a basic component of an integrated multi slice X-ray detector. In this detector, multi slice pixel array 10 and processing circuit 6 are in the same substrate of integrated sensor array 7.

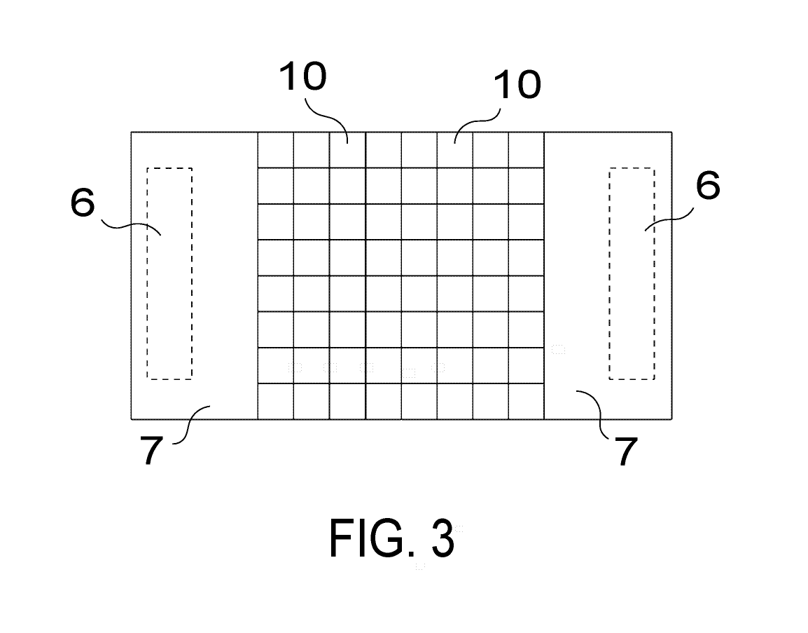

FIG. 3 shows the configuration that would effectively double numbers of slices in a multi slice X-ray detector. In this case, iCT speed will increase with the increase of numbers of lines or slices.

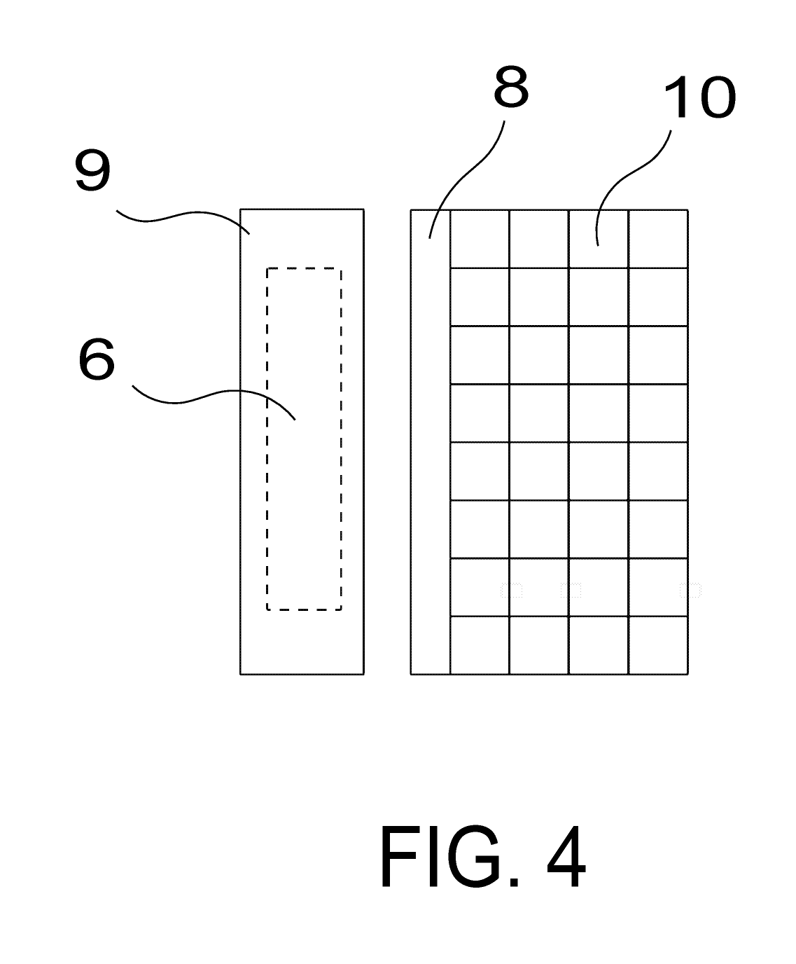

FIG. 4 shows an alternative implementation of a multi slice X-ray detector. In this detector, multi slice pixel array 10 and processing circuit 6 are in separate substrates. Multi slice pixel array 10 is in pixel array substrate 8 while processing circuit 6 is in processing circuit substrate 9. In this case, connection between Multi slice pixel array 10 and processing circuit 6 is usually through wire bonding.

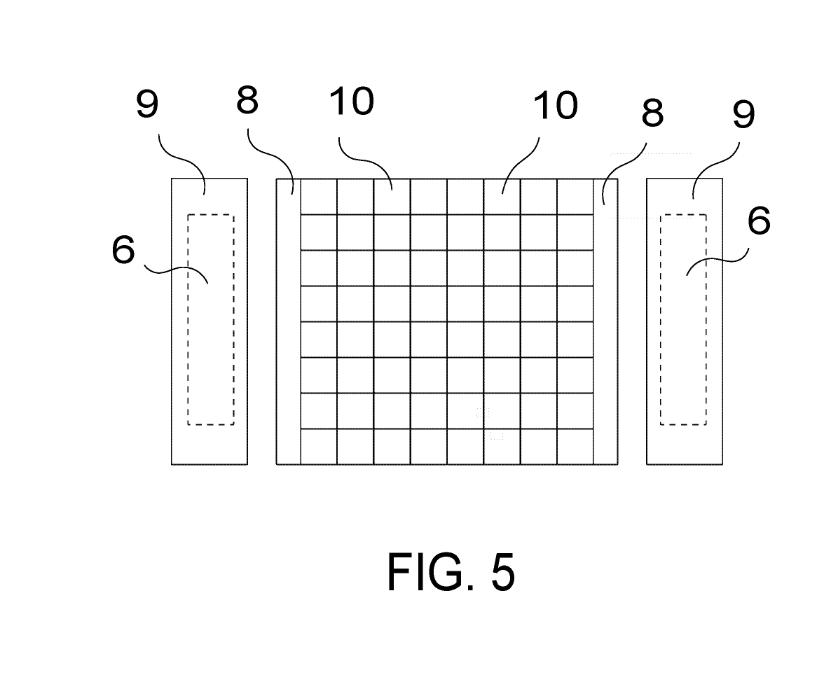

FIG. 5 shows the alternative configuration that would double numbers of slices in a multi slice X-ray detector. Also in this case, iCT speed will also increase with the increase of numbers of lines.

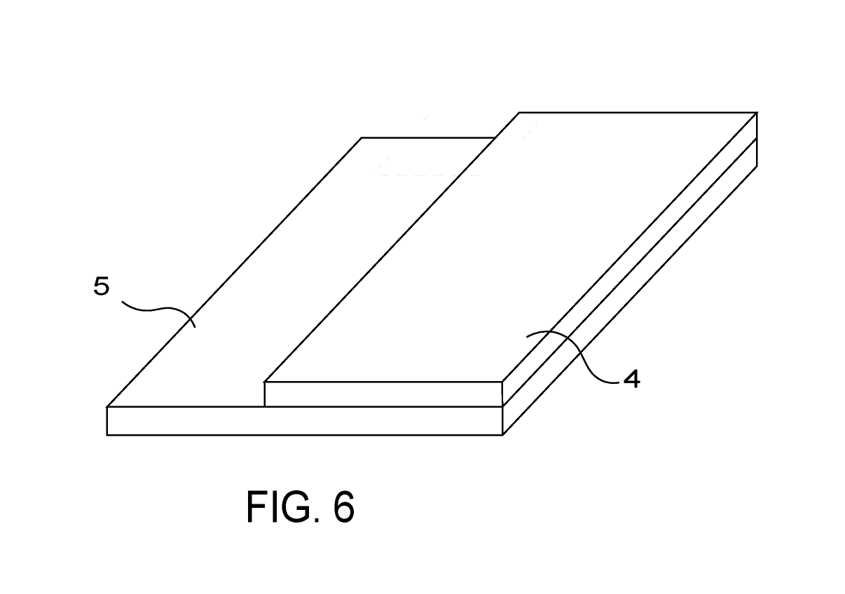

FIG. 6 shows that a scintillating material 4 is attached on the multi slice pixel array 10 area. Scintillating material 4 can be a single piece material such as Gd₂O₂S:Tb (GOS or GADOX), GOS or segmented material like such as CdWO₄ (CWO), or GAGG:Ce (GAGG). Scintillating material 4 usually is glued on the multi slice pixel array 10.

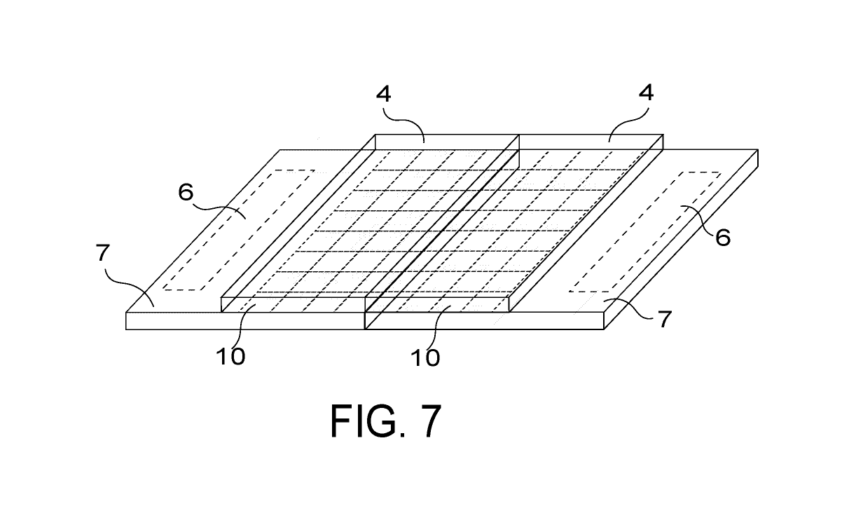

FIG. 7 shows a multi slice X-ray detector after scintillating material 4 is attached on the area of multi slice pixel array 10. Two separate detectors are placed head-to-head to double numbers of slices

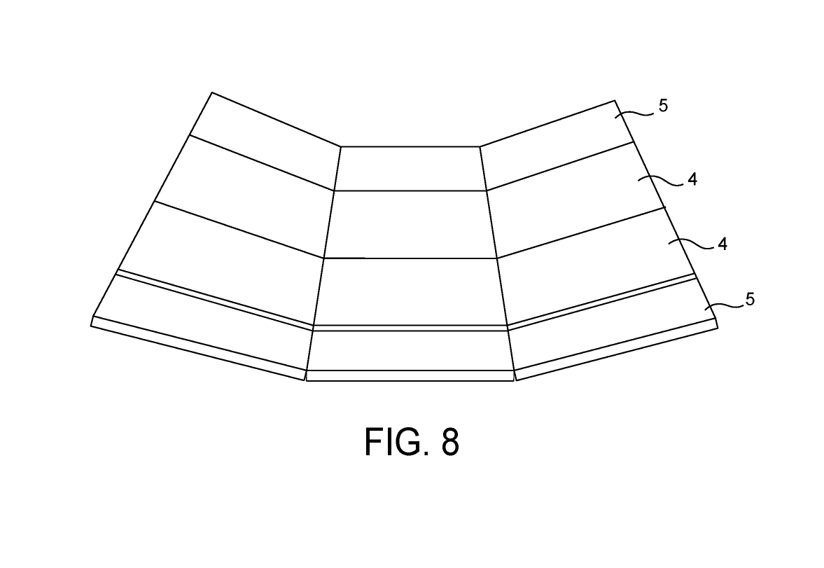

FIG. 8 shows how a curved-geometry is achieved at iCT detector. The multi slice X-ray detector is then mounted in mechanical structure of a rotational gantry. Because the detectors are in modules so it is easy to replace individual part. The substrate of integrated sensor array 7 is usually placed on other material such as PCB, glass etc.

With increasing popularity of wireless data acquisition such as 5G, it is possible to build even simpler iCT machine using the invention. Total numbers of multi slice X-ray detector needed to make a curve on a rotational gantry would largely depend on application and X-ray source beam angle.

The above disclosure is not intended as limiting. Those skilled in the art will readily observe that variations and alterations of the device may be made while retaining the teachings of the invention. Accordingly, the above disclosure should be construed as limited only by the restrictions of the following claims.

I claim:

1. An X-ray detector comprising:
a two dimensional photodiode array coupled to the layer of scintillating material and configured to detect the light output from the scintillating material and generate the analog electrical signals responsive thereto; and
a layer of scintillating material to receive x-rays attenuated through the object and generate a light output responsive thereto; and
a set of peripheral circuits comprising pixel signal processing circuits, global video signal processing circuits, and timing generators which generate all control clocks necessary for operation of the detector.

2. The X-ray detector of claim 1, wherein the photodiode array is located in the same substrate.

3. The X-ray detector of claim 1, wherein peripheral circuits are located in the same substrate as that of the photodiode array.

4. The X-ray detector of claim 1 wherein the photodiode array is separated from the peripheral circuits on the detector array substrate by a distance sufficient to allow the modulated X-ray beam to impinge on the photodiode array, but not on the peripheral circuits.

5. The X-ray detector of claim 1 wherein: the photodiode array is precisely positioned on the substrate by chip on-board assembly technology to accurately register a position of the photodiode array with respect to the substrate.

6. The X-ray detector described in claim 1 the photodiode array is buttable.

7. The X-ray detector of claim 1 wherein: the peripheral circuits are protected from impingement of the modulated X-ray beam by a metal shield.

8. An X-ray detector comprising:
a two dimensional photodiode array coupled to the layer of scintillating material and configured to detect the light output from the scintillating material and generate the analog electrical signals responsive thereto; and
a layer of scintillating material to receive x-rays attenuated through the object and generate a light output responsive thereto; and
a set of peripheral circuits comprising pixel signal processing circuits, global video signal processing circuits, and timing generators which generate all control clocks necessary for operation of the detector.

9. The X-ray detector of claim 8, wherein peripheral circuits are located in a separate piece of substrate.
